(19) United States
(12) Patent Application Publication
(10) Pub. No.: US 2022/0127429 A1
(43) Pub. Date: Apr. 28, 2022

(54) BODY SUPPORT ARTICLES COMPRISING VISCOELASTIC FOAMS AND COPPER-BASED ANTIMICROBIAL AND/OR ANTIVIRAL MATERIALS

(71) Applicant: SINOMAX USA INC., Houston, TX (US)

(72) Inventors: Ellee Elchaer, Houston, TX (US); John Beliveau, Mooresville, NC (US)

(73) Assignee: SINOMAX USA INC., Houston, TX (US)

(21) Appl. No.: 17/508,836

(22) Filed: Oct. 22, 2021

Related U.S. Application Data
(60) Provisional application No. 63/104,859, filed on Oct. 23, 2020.

(51) Int. Cl. C08J 9/00; C08G 18/76; A47C 27/14; A47C 31/00

(52) U.S. Cl. CPC C08J 9/0066; C08G 18/7621; C08K 2003/2248; A47C 31/007; A47C 27/14

(57) ABSTRACT

A body support article, comprising a viscoelastic foam layer, and water insoluble copper oxide particles, wherein a portion of the particles are exposed on at least one surface of the body support article. The copper particles may be embedded in the viscoelastic foam layer or in a cover comprising a polymer, wherein the cover is positioned over viscoelastic foam layer on the least one surface. Methods of making such body support articles.

### BACKGROUND OF THE INVENTION

### Field of the Invention

Generally, the present disclosure relates to body support articles, such as mattresses, and, more specifically, to body support devices comprising viscoelastic foams and copper-based antimicrobial and/or antiviral materials.

### Description of the Related Art

Biohazards, such bacteria, virus, etc., attaching themselves on materials are of concern. The coronavirus pandemic sweeping the planet in 2020 emphasizes the need for people to avoid infectious agents in their environment. To address this need, people are turning to frequent disinfection of various surfaces with which they come into contact. Unfortunately, this requires extreme diligence, with repeated applications of disinfecting agents to surfaces of interest. Further, some disinfecting agents may be corrosive and/or otherwise chemically reactive with materials commonly used in household appliances.

Foam mattresses, such as viscoelastic or so-called “memory foam” mattresses, have grown rapidly in market share since the turn of the century. Viscoelastic foam layers in such mattresses are commonly formed by combining an isocyanate, such as toluene diisocyanate (TDI) or methylene diisocyanate (MDI), with one or more polyols, thereby yielding a polyurethane. Though highly effective at providing comfort to users, viscoelastic foams may be susceptible to damage from common disinfecting agents. Such damage may render the mattress uncomfortable, but consumers may perceive the risk of this damage as a necessary price to pay for reducing the survivability of infectious agents on a porous surface on which the consumer may spend 6-8 hours every night.

Accordingly, it would be desirable to reduce the survivability of infectious agents on mattresses and other body support articles, i.e., to impart antimicrobial and/or antiviral properties to body support articles.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to a body support article, comprising a viscoelastic foam layer, and water insoluble copper oxide particles, wherein a portion of the particles are exposed on at least one surface of the body support article.

In one embodiment, the present disclosure is directed to a first method, comprising combining at least one polyol, at least one isocyanate, and water insoluble copper oxide particles, to yield a viscoelastic foam layer; and forming a body support article comprising the viscoelastic foam layer, wherein a portion of the particles are exposed on at least one surface of the body support article.

In one embodiment, the present disclosure is directed to a second method, comprising combining at least one polyol and at least one isocyanate, to yield a viscoelastic foam layer; mixing water insoluble copper oxide particles with at least one polymer, to yield a mixture; forming the mixture into a cover, wherein the cover is configured to fit over at least one surface of the viscoelastic foam layer and provide at least one surface of a body support article; and covering the at least one surface of the viscoelastic foam layer with the cover, to form the body support article, wherein a portion of the particles are exposed on the at least one surface of the body support article.

The present disclosure may provide for body support articles having antimicrobial and/or antiviral properties. Though not to be bound by theory, such properties may be imparted by the copper oxide particles exposed on the surface(s) of the body support article.

### BRIEF DESCRIPTION OF THE DRAWINGS

The disclosure may be understood by reference to the following description taken in conjunction with the accompanying drawings, in which like reference numerals identify like elements, and in which:

FIG. 1 depicts a stylized top view of a mattress, in accordance with embodiments herein.

FIG. 2 depicts a stylized side view of a first mattress, in accordance with embodiments herein.

FIG. 3 depicts a stylized side view of a second mattress, in accordance with embodiments herein.

FIG. 4 depicts a stylized side view of a third mattress, in accordance with embodiments herein.

FIG. 5 depicts a stylized side view of a fourth mattress, in accordance with embodiments herein.

FIG. 6 presents a flowchart of a first method, in accordance with embodiments herein.

FIG. 7 presents a flowchart of a second method, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein may provide body support articles, such as mattresses containing a viscoelastic foam layer, that have antimicrobial and/or antiviral properties.

In one embodiment, the present disclosure relates to a body support article, comprising a viscoelastic foam layer, and water insoluble copper oxide particles, wherein a portion of the particles are exposed on at least one surface of the body support article. For the avoidance of doubt, the entirety of the particles would be “a portion” thereof.

Viscoelastic foams, and layers of body support articles formed therefrom, are known in the art. Typically, they comprise polyurethanes generated by polymerizing one or more polyols with one or more isocyanates, as is known to the person of ordinary skill in the art. In exemplary embodiments, the viscoelastic foam layer may comprise from about 15 weight parts to about 75 weight parts toluene diisocyanate (TDI) residues per 100 weight parts polyol residues; the viscoelastic foam layer has an irregular cell structure; and/or the viscoelastic foam layer has a density less than or equal to 2 pounds/cubic foot (0.032 g/cm³), an air flow greater than or equal to 2.5 CFM, a recovery time greater than or equal to 4 seconds, an indentation force deflection (IFD) less than or equal to 10 pounds/square foot (478.8 Pa), and a height loss less than or equal to 10% after prolonged compression of 90% of an original height. Viscoelastic foams of these exemplary embodiments are described in more detail in a provisional application filed concurrently herewith, entitled “Low-Density Viscoelastic Foams, Body Support Articles Comprising Same, And Methods For Making Same,” assigned to Sinomax USA, Inc and incorporated herein by reference.

Water insoluble copper oxide particles are known. In exemplary embodiments, at least 95% of the water insoluble copper oxide particles may have a size between 0.25 microns and 10 microns; and/or may comprise cupric oxide particles and cuprous oxide particles. Water insoluble copper oxide particles of these exemplary embodiments and methods of incorporating them into various materials are described in more detail in U.S. Patent Appl. Pubs. US 2004/0224005, US 2013/0195841, US 2008/0241530, US 2007/0184079, US 2016/0120185, US 2016/0128323, US 2004/0247653, US 2011/0262509, US 2014/0141073, US 2015/0218321, US 2013/0011458, US 2018/0022879, US 2016/0338359, US 2008/0193496, US 2005/0049370, US 2005/0048131, and US 2008/0255285; and U.S. Pat. Nos. 7,169,402; 8,741,197; 9,439,437; and 10,238,117, all assigned to and/or applied for by Cupron, Inc. (Richmond, Va.), all of which are hereby incorporated herein by reference.

Though not to be bound by theory, water insoluble copper oxide particles exposed on at least one surface of the body support article may be harmful or fatal to bacteria, fungi, molds, and/or viruses. Further not to be bound by theory, the copper oxide particles may release copper ions that are soluble in aqueous solutions, such as mucus, phlegm, sweat, body secretions, and/or droplets or aerosols thereof, that may come in contact with the surface exposing the copper oxide particles.

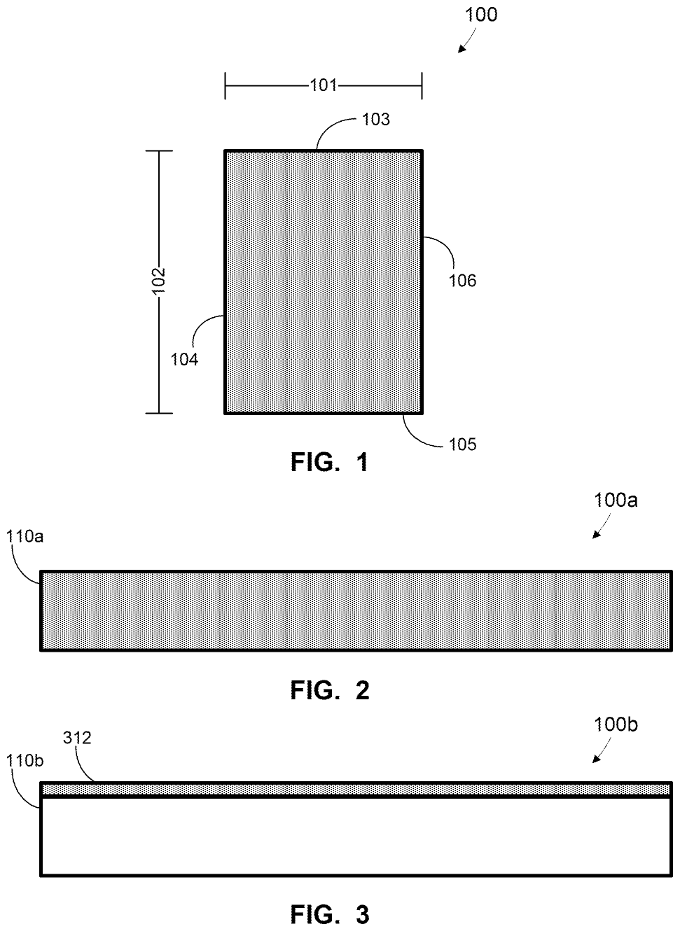

Body support articles refer to articles intended to at least partially bear the weight of at least a portion of a human or animal body, thereby providing comfort to the human or animal. In one embodiment, the body support article is a mattress, a mattress topper, a pillow, or a cushion. An exemplary body support article will be described with reference to FIG. 1 through FIG. 5.

Turning to FIG. 1, a stylized top view of a mattress 100, in accordance with embodiments herein, is illustrated. The mattress 100 has a generally rectangular profile in top view, with opposed shorter sides 103, 1205 each having a dimension 101, and opposed longer sides 104, 106 each having a dimension 102. Typically, the shorter sides 103, 105 provide the head and foot ends, respectively, of the mattress 100, and the longer sides 104, 106 provide the sides of the mattress 200.

FIG. 2 illustrates a stylized side view of a first mattress 100a, in accordance with embodiments herein. The side view shows one of the longer sides 104 or 106. In the depicted embodiment, the first mattress 100a comprises a single viscoelastic foam layer 110a. In the first mattress 100a, the water insoluble copper oxide particles are dispersed in the viscoelastic foam layer 110a.

In one embodiment, the body support article comprises from 0.25 weight parts to 15 weight parts of the particles per 100 weight parts of the viscoelastic foam layer.

FIG. 3 depicts a stylized side view of a second mattress 100b, in accordance with embodiments herein. In this embodiment, the mattress 100b comprises a viscoelastic foam layer 110b. The bulk of the viscoelastic foam layer 110b, shown by plain fill in FIG. 3, lacks copper oxide particles. The copper oxide particles are dispersed in a zone 312 of the viscoelastic foam layer 110b, wherein the zone extends from at least one surface (e.g., as depicted in FIG. 3, a top surface of the second mattress 100b) to a depth less than 6 inches (15 cm) into the viscoelastic foam layer.

The second mattress 100b may be advantageous in that the amount of copper oxide particles needed to provide antimicrobial and/or antiviral properties to the top surface of the second mattress 100b may be far less than the amount needed to disperse the copper oxide particles throughout the viscoelastic foam layer. For a qualitative comparison, bearing in mind that the figures are not necessarily to scale, the reader may compare the cross-sectional area of viscoelastic foam layer 110a in FIG. 2 to the area of the zone 312 in FIG. 3.

In the embodiment of FIG. 3, the body support article may comprise from 0.25 weight parts to 15 weight parts of the particles per 100 weight parts of viscoelastic foam in the zone.

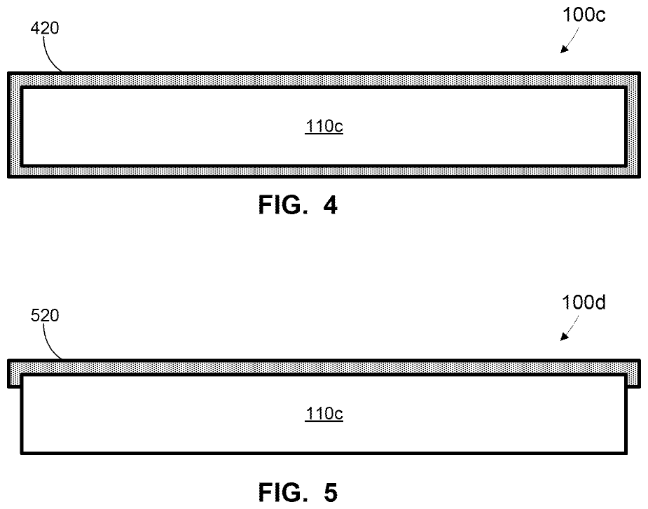

FIG. 4 depicts a stylized side view of a third mattress 100c, in accordance with embodiments herein. In the third mattress 100c, the viscoelastic foam layer 110c substantially lacks copper oxide particles. The third mattress 100c further comprises a cover 420 on at least one surface of the body support article. In the third mattress 100c, the water insoluble copper oxide particles are dispersed in the cover 420.

FIG. 4 shows an embodiment wherein the cover 420 is disposed over multiple surfaces of the viscoelastic foam layer 110c. FIG. 5 is similar, differing only in that the cover 520 is disposed over the top surface of the viscoelastic foam layer 110c of a fourth mattress 100d, e.g., the cover 520 may be a mattress topper or a fitted sheet. The embodiments of FIG. 4 and FIG. 5 are otherwise identical, so FIG. 5 will not be described in further detail.

Returning to FIG. 4, in one embodiment, the cover 420 comprises a polymer selected from the group consisting of cotton, silk, wool, flax, fur, hair, cellulose, ramie, hemp, linen, nylons, rayons, polyamides, polyaramides, polyesters, and polyolefins.

Alternatively, or in addition, the body support article comprises from 0.25 weight parts to 15 weight parts of the particles per 100 weight parts of the polymer.

Depending on the polymer included in the cover 420, the particle size range of the copper oxide particles may, in embodiments, be narrower than that described herein. If the cover 420 comprises polyesters and/or polyamides, the copper oxide particles may range in size from 1 micron to 10 microns. If the cover 420 comprises rayon viscose, the copper oxide particles may range in size from 0.5 microns to 2 microns. In other embodiments, the copper oxide particles may range in size from 0.25 microns to 0.65 microns.

In the embodiments depicted in FIG. 2-FIG. 5, the mattress 100 is shown as comprising a viscoelastic foam layer 110 alone. In other embodiments (not shown), the viscoelastic foam layer 110 may be incorporated into the mattress 100 with one or more other layers. The other layer(s) may each comprise a viscoelastic foam, a non-viscoelastic foam, or a polyurethane foam, among other materials. In one embodiment, the other layers may comprise a non-viscoelastic foam.

The other layer(s) and the viscoelastic foam layer 110 may be bonded together by any suitable adhesive. The other layer(s) and the viscoelastic foam layer 110 may be assembled using any process and/or equipment known in the art.

The embodiment shown in FIG. 3 is merely exemplary of a mattress 200 that may comprise a viscoelastic foam layer 210 in accordance with embodiments herein. In other embodiments, the viscoelastic foam layer 210 may be the only layer of a mattress, or the mattress may further comprise layers in addition to the viscoelastic foam layer 210 and the base layer 220. All such variations in a mattress 200 will readily occur to the person of ordinary skill in the art having the benefit of the present disclosure and need not be described further.

The embodiments shown in FIG. 1-FIG. 5 are merely exemplary of a body support article that may comprise a viscoelastic foam layer 110 and copper oxide particles in accordance with embodiments herein. The person of ordinary skill in the art having the benefit of the present disclosure could readily prepare a mattress topper, a pillow, a cushion, or the like instead of a mattress without moving beyond the spirit and scope of the invention as defined by the appended claims.

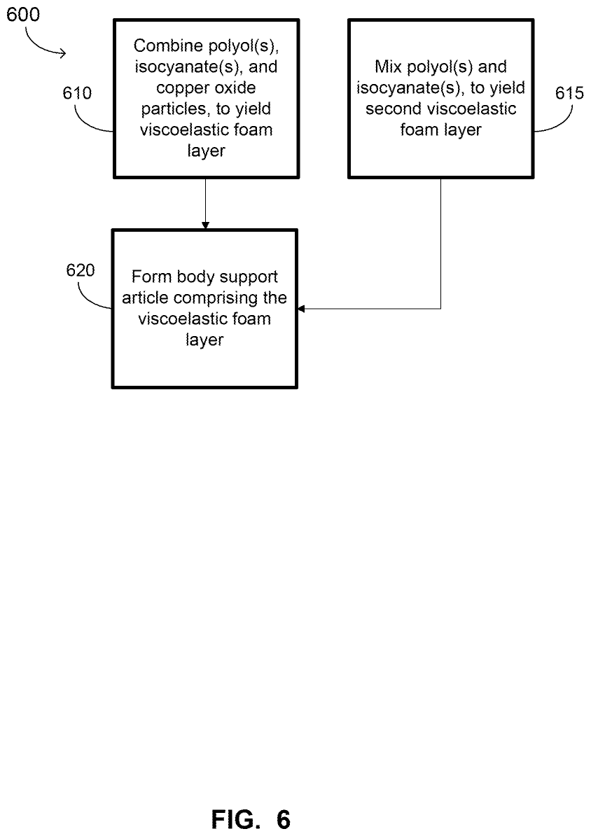

FIG. 6 presents a flowchart of a first method 600, in accordance with embodiments herein. The method 600 comprises combining (at 610) at least one polyol, at least one isocyanate, and water insoluble copper oxide particles, to yield a viscoelastic foam layer. Techniques for combining polyol(s) and isocyanate(s) are well known in the art. In particular embodiments, the techniques for combining the polyol(s) and isocyanate(s) to yield viscoelastic foam layers may be those described in more detail in a provisional application filed concurrently herewith, entitled “Low-Density Viscoelastic Foams, Body Support Articles Comprising Same, And Methods For Making Same,” assigned to Sinomax USA, Inc.

The water insoluble copper oxide particles may be combined (at 610) with the polyol(s) and the isocyanate(s) by any known technique, such as techniques set forth in the patents and published applications assigned to and/or applied for by Cupron, Inc., previously incorporated by reference.

In one embodiment, at least 95% of the particles may have a size between 0.25 microns and 10 microns. Alternatively, or in addition, the particles may comprise cupric oxide particles and cuprous oxide particles.

In one embodiment, combining (at 610) may comprise combining from about 0.25 weight parts to about 30 weight parts of the particles and from about 15 weight parts to about 75 weight parts total isocyanates per 100 weight parts total polyols.

The method 600 further comprises forming (at 620) a body support article comprising the viscoelastic foam layer, wherein a portion of the particles are exposed on at least one surface of the body support article.

Forming (at 620) may comprise one or more actions, depending on operator preference and selectable as a routine matter by the person of ordinary skill in the art having the benefit of the present disclosure. In one embodiment, forming (at 620) may yield a viscoelastic foam layer resembling layer 110a in FIG. 2.

In another embodiment, forming (at 620) may yield a viscoelastic foam layer resembling layer 312 in FIG. 3. In this latter embodiment, the method 600 may further comprise mixing (at 615) at least one polyol and at least one isocyanate, to yield a second viscoelastic foam layer, wherein the second viscoelastic foam layer is substantially free of the water insoluble copper oxide particles; wherein forming (at 620) the body support article comprises co-extruding the viscoelastic foam layer and the second viscoelastic foam layer, wherein the viscoelastic foam layer is disposed between the second viscoelastic foam layer and the at least one surface of the body support article. As an example, the viscoelastic foam layer yielded by combining (at 610) may have a depth of not more than 6 inches (15 cm) between the second viscoelastic foam layer and the at least one surface of the body support article.

Regardless whether mixing (at 615) and subsequent actions are performed, the viscoelastic foam layer may be formulated to have one or more desired properties. In one embodiment, the viscoelastic foam layer resulting from the combining (at 610) has a density less than or equal to 2 pounds/cubic foot (0.032 g/cm³), an air flow greater than or equal to 2.5 CFM, a recovery time greater than or equal to 4 seconds, an indentation force deflection (IFD) less than or equal to 10 pounds/square foot (478.8 Pa), and a height loss less than or equal to 10% after prolonged compression of 90% of an original height. The second viscoelastic foam layer formed if mixing (at 615) is performed may also have one or more desired properties, such as the five properties referred to immediately above.

The body support article resulting from forming (at 620) may be a mattress, a mattress topper, a pillow, or a cushion.

The method 600 may also comprise additional steps, not shown, to form one or more other layers of the body support article and to bond such other layers with the viscoelastic foam layer and/or the second viscoelastic foam layer, wherein at least one surface of the final body support article comprises exposed copper oxide particles.

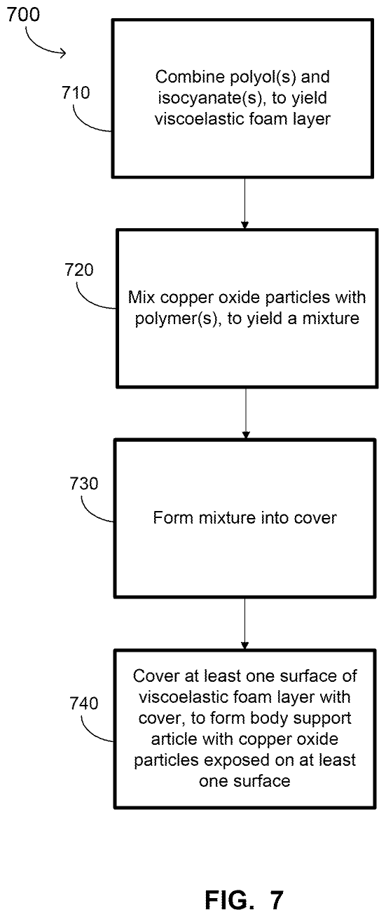

Turning now to FIG. 7, a flowchart is presented of a second method 700, in accordance with embodiments herein. In the method 700, at least one polyol and at least one isocyanate are combined (at 710), to yield a viscoelastic foam layer.

The polyol(s) and the isocyanate(s) may be combined using techniques described herein, described in the patent application assigned to Sinomax USA, Inc. and previously incorporated by reference, or commonly known in the art.

In one embodiment, combining (at 710) may comprise injecting, into a composition comprising the polyol(s), from about 15 weight parts to about 75 weight parts toluene diisocyanate (TDI) per 100 weight parts polyols.

Combining (at 710) may yield a viscoelastic foam layer having one or more desired properties. In one embodiment, the viscoelastic foam layer resulting from the combining (at 710) may have a density less than or equal to 2 pounds/cubic foot (0.032 g/cm³), an air flow greater than or equal to 2.5 CFM, a recovery time greater than or equal to 4 seconds, an indentation force deflection (IFD) less than or equal to 10 pounds/square foot (478.8 Pa), and a height loss less than or equal to 10% after prolonged compression of 90% of an original height.

The method 700 also comprises mixing (at 720) water insoluble copper oxide particles with at least one polymer, to yield a mixture. The polymer(s) may be selected from the group consisting of cotton, silk, wool, flax, fur, hair, cellulose, ramie, hemp, linen, nylons, rayons, polyamides, polyaramides, polyesters, and polyolefins. Other polymers may be used, if so desired.

The polymer(s) and the copper oxide particles may be mixed (at 720) using techniques described herein, described in the patents and published applications assigned to and/or applied for by Cupron, Inc. and previously incorporated by reference, or commonly known in the art.

In mixing (at 720), in embodiments, at least 95% of the particles in the mixture have a size between 0.25 microns and 10 microns. Alternatively, or in addition, the mixture may comprise from 0.25 weight parts to 15 weight parts of the particles per 100 weight parts of the polymer. Alternatively, or in addition to either of the foregoing embodiments, the particles in the mixture may comprise cupric oxide particles and cuprous oxide particles.

The method 700 also comprises forming (at 730) the mixture into a cover, wherein the cover is configured to fit over at least one surface of the viscoelastic foam layer and provide at least one surface of a body support article.

Techniques for forming mixtures of polymer(s) and copper oxide particles into consumer articles, such as a cover for a viscoelastic foam layer and/or a body support article, will be known to the person of ordinary skill in the art having the benefit of the present disclosure and may be implemented as a routine matter.

The method 700 further comprises covering (at 740) the at least one surface of the viscoelastic foam layer with the cover, to form the body support article, wherein a portion of the particles are exposed on the at least one surface of the body support article.

Any body support article may be formed by the method 700. For example, the body support article may be a mattress, a mattress topper, a pillow, or a cushion.

The method 700 may also comprise additional steps, not shown, to form one or more other layers of the body support article and to bond such other layers with the viscoelastic foam layer and/or the second viscoelastic foam layer, wherein at least one surface of the final body support article comprises exposed copper oxide particles.

For the avoidance of doubt, and in accordance with practice before the United States Patent and Trademark Office, none of the present figures are to scale.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A body support article, comprising:
a viscoelastic foam layer, and
water insoluble copper oxide particles, wherein a portion of the particles are exposed on at least one surface of the body support article.

2. The body support article of claim 1, wherein at least 95% of the particles have a size between 0.25 microns and 10 microns.

3. The body support article of claim 1, wherein the particles comprise cupric oxide particles and cuprous oxide particles.

4. The body support article of claim 1, wherein the particles are dispersed in the viscoelastic foam layer.

5. The body support article of claim 4, comprising from 0.25 weight parts to 15 weight parts of the particles per 100 weight parts of the viscoelastic foam layer.

6. The body support article of claim 1, wherein the particles are dispersed in a zone extending from the at least one surface to a depth less than 6 inches (15 cm) into the viscoelastic foam layer.

7. The body support article of claim 6, comprising from 0.25 weight parts to 15 weight parts of the particles per 100 weight parts of the viscoelastic foam in the zones.

8. The body support article of claim 1, further comprising a cover on at least one surface of the body support article, and wherein the water insoluble copper oxide particles are dispersed in the cover.

9. The body support article of claim 8, wherein the cover comprises a polymer selected from the group consisting of cotton, silk, wool, flax, fur, hair, cellulose, ramie, hemp, linen, nylons, rayons, polyamides, polyaramides, polyesters, and polyolefins.

10. The body support article of claim 9, comprising from 0.25 weight parts to 15 weight parts of the particles per 100 weight parts of the polymer.

11. The body support article of claim 1, wherein the body support article is a mattress, a mattress topper, a pillow, or a cushion.

12. A method, comprising:
combining at least one polyol, at least one isocyanate, and water insoluble copper oxide particles, to yield a viscoelastic foam layer; and
forming a body support article comprising the viscoelastic foam layer, wherein a portion of the particles are exposed on at least one surface of the body support article.

13. The method of claim 12, wherein combining comprises combining from about 0.25 weight parts to about 30 weight parts of the particles and from about 15 weight parts to about 75 weight parts total isocyanates per 100 weight parts total polyols.

14. The method of claim 12, wherein at least 95% of the particles have a size between 0.25 microns and 10 microns.

15. The method of claim 12, wherein the particles comprise cupric oxide particles and cuprous oxide particles.

16. The method of claim 12, further comprising:
mixing at least one polyol and at least one isocyanate, to yield a second viscoelastic foam layer, wherein the second viscoelastic foam layer is substantially free of the water insoluble copper oxide particles;
wherein forming the body support article comprises co-extruding the viscoelastic foam layer and the second viscoelastic foam layer, wherein the viscoelastic foam layer is disposed between the second viscoelastic foam layer and the at least one surface of the body support article.

17. The method of claim 12, wherein the body support article is a mattress, a mattress topper, a pillow, or a cushion.

18. A method, comprising:
combining at least one polyol and at least one isocyanate, to yield a viscoelastic foam layer;
mixing water insoluble copper oxide particles with at least one polymer, to yield a mixture;
forming the mixture into a cover, wherein the cover is configured to fit over at least one surface of the viscoelastic foam layer and provide at least one surface of a body support article; and
covering the at least one surface of the viscoelastic foam layer with the cover, to form the body support article, wherein a portion of the particles are exposed on the at least one surface of the body support article.

19. The method of claim 18, wherein the particles in the mixture comprise cupric oxide particles and cuprous oxide particles.

20. The method of claim 18, wherein the body support article is a mattress, a mattress topper, a pillow, or a cushion.
